(19) United States
(12) Patent Application Publication
(10) Pub. No.: US 2006/0045129 A1
(43) Pub. Date: Mar. 2, 2006

(54) Method and apparatus for improved data delivery to mobiles using SDB signaling

(76) Inventors: Thomas B. Hart, West Dundee, IL (US); Ronald T. Crocker, St. Charles, IL (US); John M. Harris, Chicago, IL (US); Dan Zhang, Vernon Hills, IL (US)

Correspondence Address: MOTOROLA, INC., 1303 EAST ALGONQUIN ROAD, IL01/3RD, SCHAUMBURG, IL, 60196, US

(21) Appl. No.: 11/189,164

(22) Filed: Jul. 26, 2005

Related U.S. Application Data
(60) Provisional application No. 60/605,213, filed on Aug. 27, 2004.

(51) Int. Cl. H04J 3/22; H04J 3/16; H04Q 7/24; H04B 7/212; H04J 3/00; H04Q 7/00

(52) U.S. Cl. 370/468; 370/338; 370/328

(57) ABSTRACT

Various embodiments are described to address the need for improved SDB data delivery to mobiles. In general, an MS (101) will determine whether it expects to receive data that would be appropriate for delivery by SDB. If it does, then the MS, via messaging with a serving RAN (e.g., RAN-component BS 121), PCF (131), and PDSN (141), establishes a service instance and a traffic flow template (TFT) to be used to segregate data for delivery to the MS via SDB. The PCF and PDSN establish a tunnel associated with the service instance that will be used in accordance with the TFT for conveying data that is to be delivered to the MS via SDB.

### REFERENCE(S) TO RELATED APPLICATION(S)

The present application claims priority from provisional application Ser. No. 60/605,213, entitled “METHOD AND APPARATUS IMPROVED DATA DELIVERY TO MOBILES USING SDB SIGNALING,” filed Aug. 27, 2004, which is commonly owned and incorporated herein by reference in its entirety.

### FIELD OF THE INVENTION

The present invention relates generally to mobile communication systems and, in particular, to improving data delivery to mobiles using short data burst (SDB) signaling.

### BACKGROUND OF THE INVENTION

Short Data Burst (SDB) signaling can be a relatively efficient way to send data to a dormant mobile without setting up a traffic channel (TCH). However, SDBs are limited by the size of the payload they can convey over a system's common or dedicated channels. Thus, the size of a packet would seem to be the controlling factor for determining whether delivery by SDB is appropriate or not.

There are several size-based approaches that use the maximum SDB packet size as the trigger for delivery by SDB. However, these approaches can be problematic when many small packets are being sent to the mobile over a short period of time. Sending these packets as multiple SDBs in the forward direction can not only be significantly slower than sending them via a traffic channel, it can degrade the paging capacity of the system.

Thus, determining when SDB signaling is more desirable for transferring data than TCH setup is difficult, especially for a network component such as a packet control function (PCF), which is not application aware. When a PCF receives an SDB-sized packet should it immediately send it via an SDB? Or is this packet but one of many about to be received by the PCF for the same mobile? At present, this is a dilemma that adversely affects the efficiency of data delivery to dormant mobiles. Therefore, it would be desirable to have a method and apparatus that improves upon existing SDB data delivery to mobiles by addressing this dilemma.

### BRIEF DESCRIPTION OF THE DRAWINGS

FIG. 1 is a block diagram depiction of a mobile communication system in accordance with multiple embodiments of the present invention.

FIGS. 2a-2c, considered together (hereinafter “FIG. 2”), form a messaging flow diagram depicting the establishment and use of a service instance and traffic flow template (TFT) to segregate data for SDB delivery to an MS in accordance with multiple embodiments of the present invention.

### DETAILED DESCRIPTION OF EMBODIMENTS

Various embodiments are described to address the need for improved SDB data delivery to mobiles. In general, an MS will determine whether it expects to receive data that would be appropriate for delivery by SDB. If it does, then the MS, via messaging with a serving RAN, PCF, and PDSN, establishes a service instance and a traffic flow template (TFT) to be used to segregate data for delivery to the MS via SDB. The PCF and PDSN establish a tunnel associated with the service instance that will be used in accordance with the TFT for conveying data that is to be delivered to the MS via SDB.

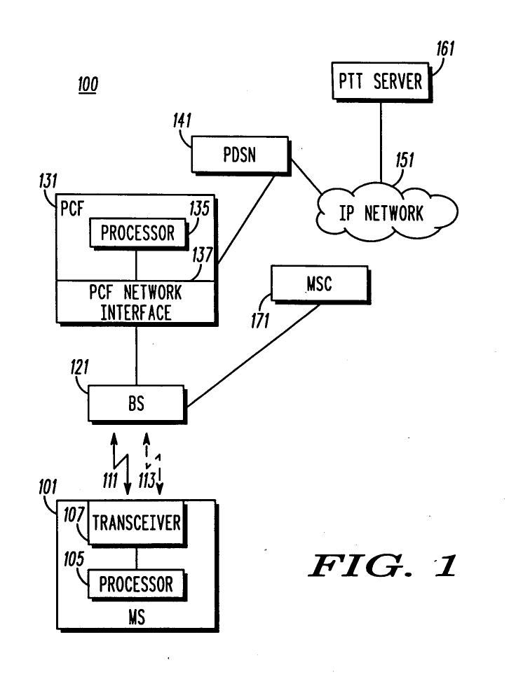

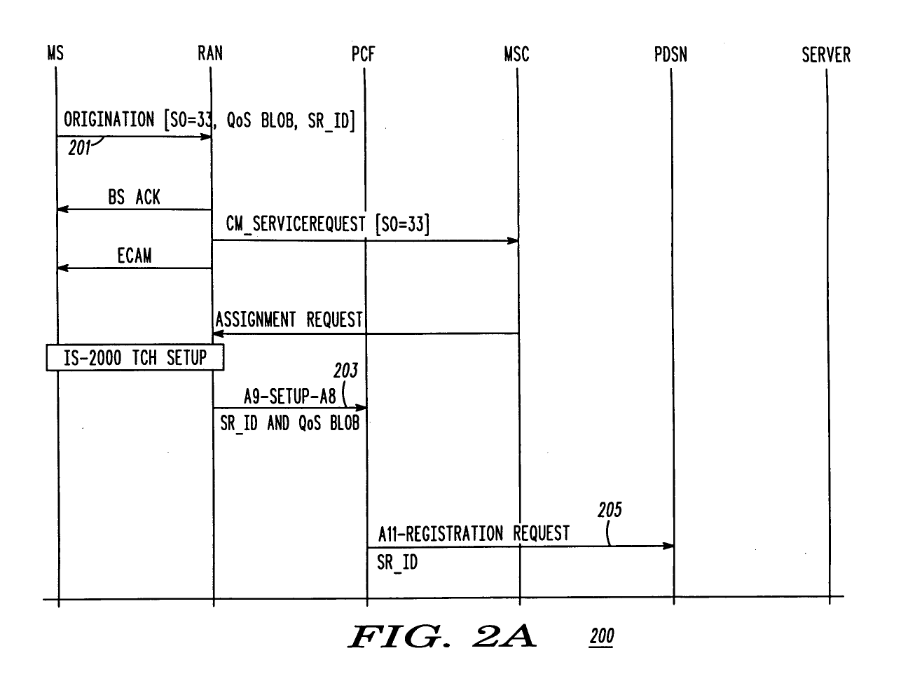

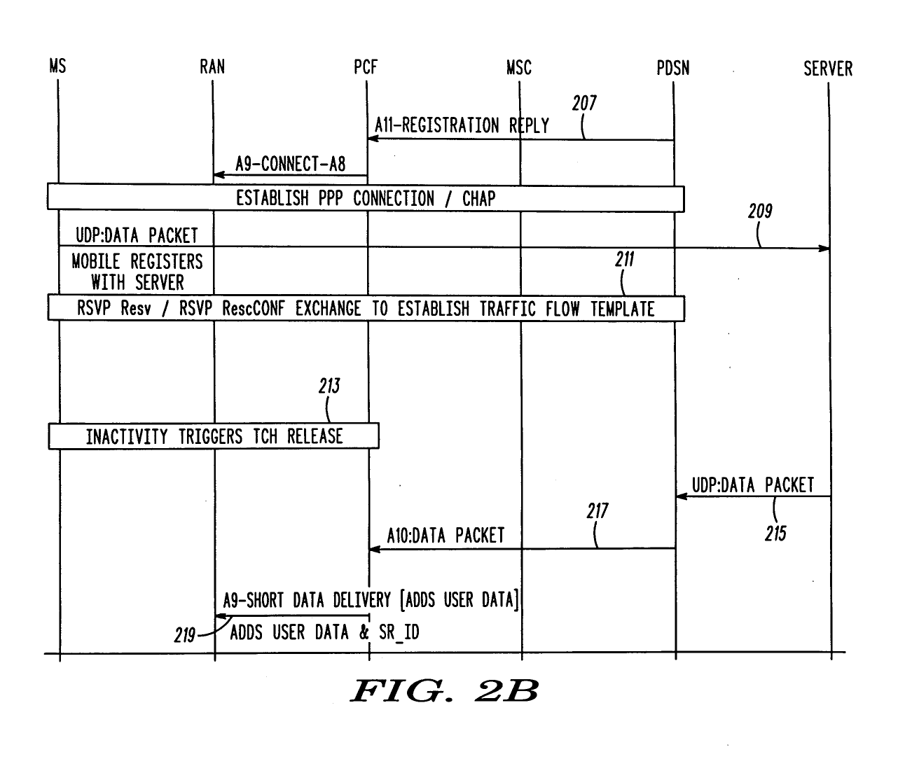

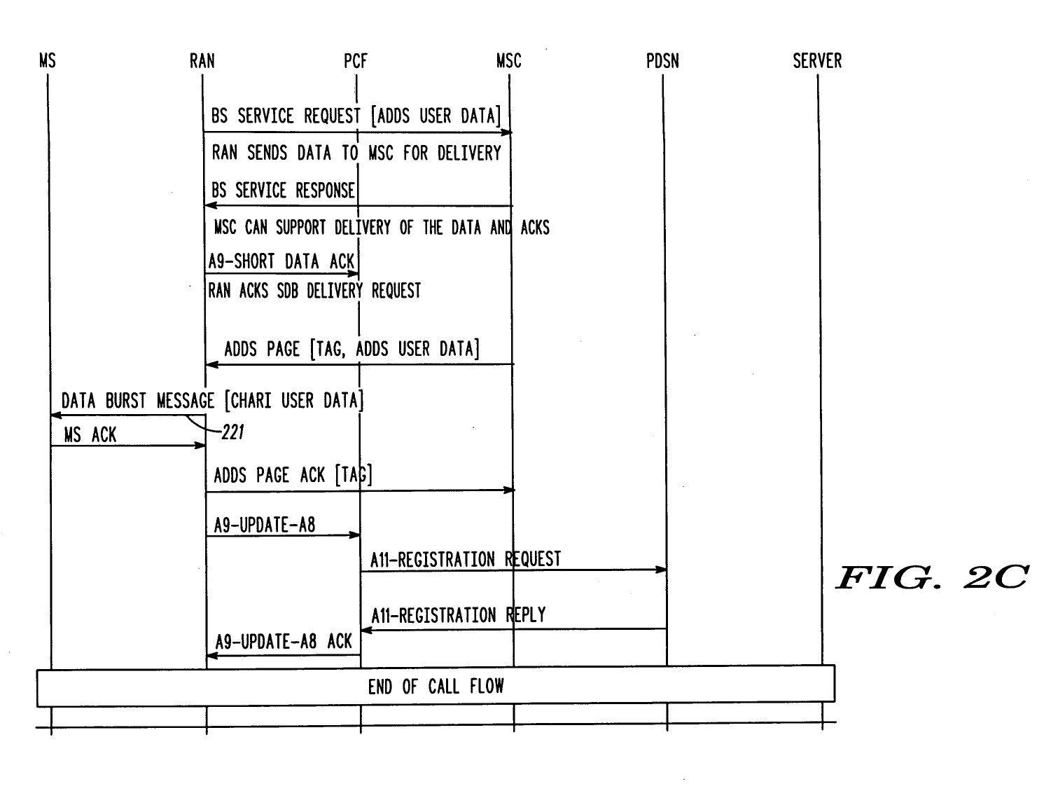

The disclosed embodiments can be more fully understood with reference to FIGS. 1 and 2. FIG. 1 is a block diagram depiction of a mobile communication system 100 in accordance with multiple embodiments of the present invention. Communication system 100 is a well-known Code Division Multiple Access (CDMA) system, specifically a cdma2000 system, which is based on the Telecommunications Industry Association/Electronic Industries Association (TIA/EIA) standards IS-2000 and IS-2001, suitably modified to implement the present invention. Alternative embodiments of the present invention may be implemented in communication systems that employ other technologies similar to IS-2000 and IS-2001.

Those skilled in the art will recognize that FIG. 1 does not depict all of the network equipment necessary for system 100 to operate but only those system components and logical entities particularly relevant to the description of embodiments of the present invention. In particular, the network equipment of system 100 comprises components such as base station (BS) 121, mobile switching center (MSC) 171, packet control function (PCF) 131, packet data serving node (PDSN) 141, internet protocol (IP) network 151, and data server 161. Generally, BSs, MSCs, PCFs, PDSNs, IP networks, and data servers are known in the art. For example, BSs are well-known to comprise components such as base station controllers (BSCs) and base transceiver systems (BTSs), neither of which are specifically shown in FIG. 1. Also, PCFs are well-known to comprise components such as processors and PCF network interfaces.

PCF 131 is depicted in FIG. 1 as comprising processor 135 and PCF network interface 137. In general, components such as PCF processors and PCF network interfaces are well-known. For example, PCF processors are known to comprise basic components such as, but not limited to, microprocessors, microcontrollers, memory devices, and/or logic circuitry. Such PCF components are typically adapted to implement algorithms and/or protocols that have been expressed using high-level design languages or descriptions, expressed using computer instructions, expressed using messaging flow diagrams, and/or expressed using logic flow diagrams. Thus, given an algorithm, a logic flow, a messaging flow, and/or a protocol specification, those skilled in the art are aware of the many design and development techniques available to implement a PCF that performs the given logic. Therefore, PCF 131 represents a known PCF that has been adapted, in accordance with the description herein, to implement embodiments of the present invention.

BS 121 and remote unit 101 use an air interface comprising channel groups 111 and 113 to communicate. IS-2000 channel group 111 comprises a variety of well-known non-traffic channel types, such as broadcast channels, paging channels, access channels (i.e., access channels (ACHs) and enhanced access channels (EACHs)), and common control channels. IS-2000 channel group 113 comprises dedicated traffic channels, which are dynamically assigned and de-assigned to support user services.

IS-2000 terminology refers to remote units as mobile stations (MSs); however, remote units are not necessarily mobile nor able to move. Thus, remote unit/MS platforms are known in the art to include devices such as mobile phones, computers, personal digital assistants, gaming devices, etc. In particular, MS 101 comprises processor 105, transceiver 107, a keypad (not shown), a speaker (not shown), a microphone (not shown), and a display (not shown). Processors, transceivers, keypads, speakers, microphones, and displays as used in MSs are generally well-known in the art.

For example, MS processors are known to comprise basic components such as, but not limited to, microprocessors, digital signal processors (DSPs), microcontrollers, memory devices, and/or logic circuitry. Such MS components are typically adapted to implement algorithms and/or protocols that have been expressed using high-level design languages or descriptions, expressed using computer instructions, expressed using messaging flow diagrams, and/or expressed using logic flow diagrams. Thus, given an algorithm, a logic flow, a messaging flow, and/or a protocol specification, those skilled in the art are aware of the many design and development techniques available to implement an MS that performs the given logic. Thus, MS 101 represents a known MS that has been adapted, in accordance with the description herein, to implement embodiments of the present invention.

Operation of embodiments in accordance with the present invention occurs substantially as follows. FIG. 2 shows messaging flow diagram 200 depicting the establishment and use of a service instance and traffic flow template (TFT) to segregate data for SDB delivery to an MS in accordance with multiple embodiments of the present invention.

Relevant operation begins with processor 105 of MS 101 determining whether it expects to receive data that would be appropriate for delivery to MS 101 via SDB. For example, does MS 101 anticipate receiving unsolicited data (or “push” data) in the form of individual bursts, each able to fit within a single SDB, from a server or application? Particular examples of such data that MS 101 may expect to receive include instant messaging, presence updates, short message service (SMS) via data, push-to-talk (PTT) session requests, session initiation protocol (SIP) messages (such as 100 TRYING or 200 OK), call alerts (including PTT talk requests without audio), or user information updates (news, stock quotes, weather, traffic, location, sports, etc.). Large data downloads (emails, music, video, etc.) or streaming data for voice, multimedia, etc. would not be appropriate for SDB delivery.

After determining that data appropriate for SDB delivery is expected, processor 105 of MS 101 establishes, via transceiver 107, a first service instance and a first traffic flow template (TFT) to be used to segregate data for delivery to MS 101 via SDB. As an example illustrating how these may be established, FIG. 2 depicts MS 101 establishing a data session that includes the first service instance by sending a data service origination (origination message 201) to the RAN (i.e., to RAN-component BS 121 via an access channel in channel group 111).

To establish the service instance for SDB data, MS 101 includes a service identifier (SR_ID) and a QoS_BLOB in origination message 201. The RAN (BS 121), in turn, conveys the SR_ID and QoS_BLOB to PCF 131 in A9-Setup-A8 message 203. QoS_BLOBs are defined in TIA/EIA/IS-707-A-2, “Data Service Options for Spread Spectrum Systems—Addendum 2 PN-4692.” The QoS_BLOB sent to PCF 131 via the RAN has an Assured Mode field set to a value indicating a Non-Assured setting and a reserved portion of a Non-Assured Priority field set to a value indicating an SDB Appropriate setting. These particular field settings, of course, represent but one of many possible ways that a QoS_BLOB may be used to indicate the appropriateness of data delivery to MS 101 via SDB for this service instance. Moreover, the use of a QoS_BLOB is but one of many possible mechanisms for an MS to use to establish a service instance dedicated to SDB data.

In response to receiving A9-Setup-A8 message 203 via PCF network interface 137, PCF processor 135 establishes with PDSN 141, via PCF network interface 137, a first tunnel that is associated with the first service instance. FIG. 2 depicts PCF 131 establishing the first tunnel by sending A11-Registration Request message 205 (which includes the SR_ID for the first service instance) to PDSN 141, and PDSN 141 responding with A11-Registration Reply message 207.

Just as the MS and PCF established a service instance and tunnel by which data for delivery to the MS via SDB may be segregated, one or more additional service instances may be established to segregate data for delivery to the MS via a non-SDB method. For example, when the MS expects to receive data that would not be appropriate for delivery by SDB a second service instance and tunnel may be established for handling the data to be delivered by non-SDB means.

To do this, MS 101 would send a second SR_ID and a second QoS_BLOB to PCF 131 via the RAN. One of many possible ways to indicate that the second service instance is for data to be delivered by non-SDB means is to set an Assured Mode field in the second QoS_BLOB to a value indicating an Assured setting. Another way is to set an Assured Mode field of the second QoS_BLOB to a value indicating a Non-Assured setting and to set a reserved portion in a Non-Assured Priority field to a value indicating an SDB inappropriate setting.

In addition to establishing one or more service instances, processor 105 of MS 101 establishes, via transceiver 107 and a traffic channel from channel group 113, one or more corresponding traffic flow templates (TFTs). As an example illustrating how these may be established, FIG. 2 depicts MS 101 establishing a point-to-point (PPP) connection with PDSN 141 and then registering with internet server 161 using messaging 209. Using RSVP protocol messaging 211, MS 101 and PDSN 141 establish the TFT(s). (RSVP is defined in Internet Engineering Task Force RFC 2205 and a 3GPP2 TFT object is defined in IS-835.4-C, Appendix B.)

In setting up a TFT for the first service instance, MS 101 indicates to PDSN 141 which data packets should be mapped to the first service instance. For example, MS 101 may indicate that packets associated with a certain protocol, addressed to a certain port number, or containing a certain IP address be mapped to the first service instance. As described above, MS 101 may establish one or more additional service instances and tunnels such as a second set for use segregating data to be delivered by a non-SDB means. MS 101 would then also establish a second (or additional) TFT, indicating to PDSN 141 which data packets should be delivered by non-SDB means via the second service instance and tunnel.

At some time after MS 101's present traffic channel and perhaps subsequent MS 101 traffic channels have been released, as generically represented by messaging 213, internet server 161 sends data (messaging 215) to MS 101 via PDSN 141. In accordance with its TFT(s), PDSN 141 sends the data (messaging 217) to PCF 131 via the TFT-indicated, A10 tunnel. Having received the data via the first tunnel (set up for SDB data), PCF processor 135 sends the data (messaging 219) via PCF network interface 137 to the RAN for delivery to MS 101 via SDB (messaging 221). Similarly, if PCF processor 135 had received the data via the second tunnel (set up for non-SDB delivery), PCF processor 135 would send the data via PCF network interface 137 to the RAN for non-SDB delivery to MS 101. The PCF would, for example, request that the RAN/MSC page the target MS to return to a traffic channel (active state), and then deliver the data through a well-known method such as A8 packet to RAN then RAN to MS via RLP over the air interface.

In some embodiments, when the PCF receives data via the SDB tunnel, the PCF may verify that the data received is in fact able to fit within an SDB before sending it to the RAN for delivery. In addition or in the alternative, before sending the initial data to the RAN for delivery via SDB, the PCF may verify that subsequent data for the MS has not arrived for some period of time after the initial data is received. If additional data arrives, then data delivery to the MS via SDB, may be less efficient than data delivery via a traffic channel, for example. Thus, the PCF may determine to deliver the data received for the MS by non-SDB means instead.

In embodiments described above, the MS and PCF establish a service instance, a tunnel, and a TFT for each MS delivery option, SDB and non-SDB. In other embodiments, the MS and PCF may establish a service instance, a tunnel, and a TFT for more varied delivery options. For example, if the MS expects to receive data that would be appropriate for delivery by SDB and the MS application receiving the data can tolerate a paging delay, the MS and PCF may establish a service instance, a tunnel, and a TFT for data delivery to the MS via SDB but after paging the MS. Thus, the RAN would first locate the MS through paging and then transmit the data in an SDB according to a cell location determined from the MS's page response. Such a delivery mechanism would conserve paging channel bandwidth. Rather than transmitting the SDB in the whole paging area, the SDB transmission could be limited to a subset of the paging area.

However, if the MS expects to receive data that would be appropriate for delivery by SDB but the MS application receiving the data cannot tolerate a paging delay, the MS and PCF may establish a service instance, a tunnel, and a TFT for data delivery to the MS via SDB but without first paging the MS. Thus, the RAN would not first locate the MS through paging, but instead transmit the data in an SDB across a paging area large enough to reasonably expect delivery on the first try. Such a delivery mechanism would value relatively low delay over conserving paging channel bandwidth.

In the foregoing specification, the present invention has been described with reference to specific embodiments. However, one of ordinary skill in the art will appreciate that various modifications and changes may be made without departing from the spirit and scope of the present invention as set forth in the appended claims. Accordingly, the specification and drawings are to be regarded in an illustrative rather than a restrictive sense, and all such modifications are intended to be included within the scope of the present invention. In addition, those of ordinary skill in the art will appreciate that the elements in the drawings are illustrated for simplicity and clarity, and have not necessarily been drawn to scale. For example, the size of some of the elements in the drawings may be exaggerated relative to others to help improve an understanding of the various embodiments.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims. As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, computer program, and computer instructions, as used herein, are defined as a sequence of instructions designed for execution on a computer system. This sequence of instructions may include, but is not limited to, a subroutine, a function, a procedure, an object method, an object implementation, an executable application, an applet, a servlet, a shared library/dynamic load library, a source code, an object code and/or an assembly code.

What is claimed is:

1. A method for improved data delivery to mobiles using short data burst (SDB), the method comprising:
determining, by a mobile station (MS), whether the MS expects to receive data that would be appropriate for delivery by SDB;
if the MS expects to receive data that would be appropriate for delivery by SDB, establishing, by the MS, a first service instance and a first traffic flow template (TFT) to be used to segregate data for delivery to the MS via SDB.

2. The method of claim 1, wherein if the MS expects to receive data that would be appropriate for delivery by SDB and can tolerate a paging delay, establishing, by the MS, the first service instance and the first TFT to be used to segregate data for delivery to the MS via SDB after paging the MS.

3. The method of claim 1, wherein if the MS expects to receive data that would be appropriate for delivery by SDB and cannot tolerate a paging delay, establishing, by the MS, the first service instance and the first TFT to be used to segregate data for delivery to the MS via SDB without first paging the MS.

4. The method of claim 1, wherein data that would be appropriate for delivery by SDB comprises unsolicited data.

5. The method of claim 1, wherein data that would be appropriate for delivery by SDB comprises individual bursts of data, each able to fit within a single SDB.

6. The method of claim 1, wherein data that would be appropriate for delivery by SDB comprises data of a type from the group consisting of instant messaging, presence updates, short message service (SMS) via data, push-to-talk (PTT) session requests, session initiation protocol (SIP) messages, call alerts, and user information updates.

7. The method of claim 1, wherein establishing the first service instance comprises
establishing a first data session to include the first service instance.

8. The method of claim 1, wherein establishing the first service instance comprises sending a first data service origination to a radio access network (RAN).

9. The method of claim 1, wherein establishing the first service instance comprises sending a first service identifier (SR_ID) to a packet control function (PCF) via a radio access network (RAN).

10. The method of claim 1, wherein establishing the first service instance comprises sending a first QoS_BLOB to a packet control function (PCF) via a radio access network (RAN).

11. The method of claim 10, wherein an Assured Mode field of the first QoS_BLOB is set to a value indicating a Non-Assured setting and wherein a reserved field in a Non-Assured Priority field of the first QoS_BLOB is set to a value indicating an SDB Appropriate setting.

12. The method of claim 1, wherein establishing the first TFT comprises sending, to a packet data serving node (PDSN) via a radio access network (RAN), an indication of which data packets should be mapped to the first service instance.

13. The method of claim 12, wherein the indication of which data packets should be mapped to the first service instance comprises an indication that data packets should be mapped to the first service instance when the data packets have specified values for at least one field from the group consisting of port number, internet protocol (IP) address, and protocol type.

14. The method of claim 1, further comprising establishing, by the MS, a second service instance to be used to segregate data to be delivered to the MS via a non-SDB method, when the MS expects to receive data that would not be appropriate for delivery by SDB.

15. The method of claim 14, wherein establishing the second service instance comprises sending a second service identifier (SR_ID) to a Packet Control Function (PCF) via a Radio Access Network (RAN).

16. The method of claim 14, further comprising establishing a second TFT comprising an indication of which data packets should be mapped to the second service instance.

17. The method of claim 14, wherein establishing the second service instance comprises sending a second QoS_BLOB to a packet control function (PCF) via a radio access network (RAN).

18. The method of claim 17, wherein an Assured Mode field of the second QoS_BLOB is set to a value indicating an Assured setting.

19. The method of claim 17, wherein an Assured Mode field of the second QoS_BLOB set to a value indicating a Non-Assured setting and a reserved field in a Non-Assured Priority field of the second QoS_BLOB is set to a value indicating an SDB inappropriate setting.

20. A method for improved data delivery to mobiles using short data burst (SDB), the method comprising:
receiving, by a packet control function (PCF), a first service identifier (SR_ID) for a service instance to be used to segregate data for delivery to a mobile station (MS) via SDB;
establishing, by the PCF with a packet data serving node (PDSN), a first tunnel associated with the service instance;
receiving, by the PCF, data via the first tunnel; and
sending, by the PCF, the data to a radio access network (RAN) for delivery to the MS via SDB.

21. The method of claim 20,
wherein receiving the first service identifier comprises receiving the first service identifier (SR_ID) for the service instance to be used to segregate data for delivery to the MS via SDB after paging the MS and
wherein sending comprises sending, by the PCF, the data to the RAN for delivery to the MS via SDB after paging the MS.

22. The method of claim 20,
wherein receiving the first service identifier comprises receiving the first service identifier (SR_ID) for the service instance to be used to segregate data for delivery to the MS via SDB without first paging the MS and
wherein sending comprises sending, by the PCF, the data to the RAN for delivery to the MS via SDB without first paging the MS.

23. The method of claim 20, further comprising receiving, by the PCF, a QoS_BLOB for the service instance from the MS via the RAN.

24. The method of claim 23, wherein an Assured Mode field of the QoS_BLOB is set to a value indicating a Non-Assured setting and wherein a reserved field in a Non-Assured Priority field of the QoS_BLOB is set to a value indicating an SDB Appropriate setting.

25. The method of claim 20, further comprising determining, by the PCF prior to sending the data, that the data is able to fit within an SDB.

26. The method of claim 25, further comprising determining, by the PCF prior to sending the data, that additional data for the MS has not arrived during a period of time after the data is received.

27. The method of claim 20, further comprising:
receiving, by the packet control function (PCF), a second service identifier (SR_ID) for a second service instance to be used to segregate data for delivery to the mobile station (MS) via a non-SDB method;
establishing, by the PCF with the PDSN, a second tunnel associated with the second service instance;
receiving, by the PCF, data via the second tunnel; and
sending, by the PCF, the data received via the second tunnel to the RAN for delivery to the MS via a non-SDB method.

28. The method of claim 27, further comprising receiving, by the PCF, a second QoS_BLOB for the second service instance from the MS via the RAN.

29. The method of claim 28, wherein an Assured Mode field of the second QoS_BLOB is set to a value indicating an Assured setting.

30. The method of claim 28, wherein an Assured Mode field of the second QoS_BLOB set to a value indicating a Non-Assured setting and a reserved field in a Non-Assured Priority field of the second QoS_BLOB is set to a value indicating an SDB inappropriate setting.

31. A mobile station (MS) for improving data delivery using short data burst (SDB), the MS comprising:
a transceiver; and
a processor, communicatively coupled to the transceiver,
adapted to determine whether the MS expects to receive data that would be appropriate for delivery by SDB, and
adapted to establish, via the transceiver, a first service instance and a first traffic flow template (TFT) to be used to segregate data for delivery to the MS via SDB, if the MS expects to receive data that would be appropriate for delivery by SDB.

32. The MS of claim 31, wherein the processor is further adapted to establish, via the transceiver, a second service instance and a second TFT to be used to segregate data for delivery to the MS via a non-SDB method.

33. A packet control function (PCF) for improving data delivery to mobiles using short data burst (SDB), the PCF comprising:
a PCF network interface adapted to send and receive messaging using at least one communication protocol;
a processor, communicatively coupled to the PCF network interface,
adapted to receive, via the PCF network interface, a first service identifier (SR_ID) for a first service instance to be used to segregate data for delivery to a mobile station (MS) via SDB,
adapted to establish, via the PCF network interface, with a packet data serving node (PDSN), a first tunnel associated with the first service instance,
adapted to receive, via the PCF network interface, first data via the first tunnel, and
adapted to send, via the PCF network interface, the first data to a radio access network (RAN) for delivery to the MS via SDB.

34. The PCF of claim 33, wherein the processor is further
adapted to receive, via the PCF network interface, a second service identifier (SR_ID) for a second service instance to be used to segregate data for delivery to a mobile station (MS) via a non-SDB method,
adapted to establish, via the PCF network interface, with the PDSN, a second tunnel associated with the second service instance,
adapted to receive, via the PCF network interface, second data via the second tunnel, and
adapted to send, via the PCF network interface, the second data to the RAN for delivery, to the MS via the non-SDB method.
